(19) United States
(12) Patent Application Publication
(10) Pub. No.: US 2023/0416017 A1
(43) Pub. Date: Dec. 28, 2023

(54) DEVICE AND PROCESS FOR HANDLING CARDBOARD REELS

(71) Applicant: FUTURA S.P.A., Capannori (IT)

(72) Inventor: Fabio PERINI, Viareggio (IT)

(21) Appl. No.: 18/035,973

(22) PCT Filed: Dec. 9, 2021
(86) PCT No.: PCT/IT2021/050400

§ 371 Date: May 9, 2023

(30) Foreign Application Priority Data
Dec. 14, 2020 (IT) 102020000030644

(51) Int. Cl. B65G 47/90; B65G 59/04

(52) U.S. Cl. CPC B65G 47/90; B65G 59/04

(57) ABSTRACT

Device for handling cardboard reels, comprising a main body (8) with a rod (45) on which are arranged:
a first unit with two axially opposed plates (91, 92), provided with respective radially expandable parts (913, 923), and spaced apart by a predetermined value along an axial direction (A9) of said rod (45) so as to forming a pressurizable space (S) between said plates, said space (S) being delimited at the top and bottom by opposite surfaces (912, 922) of said plates (91, 92);
means for controlling the radial expansion of said parts (913, 923);
pressurization means for pressurizing said space (S).

The present invention relates to a device and a process for handling cardboard reels, especially cardboard reels used to feed machines for the production of cardboard tubes, in particular for making paper rolls with an internal tubular core. It is known that the production of logs of paper material, from which for example toilet paper rolls or kitchen paper rolls are obtained, involves feeding a paper web, formed by one or more overlapping plies, along a predetermined path along which various operations are carried out before proceeding with the formation of the logs, including a transversal pre-incision of the web to form pre-cut lines which subdivide it into tear-separable sheets. The formation of the logs normally involves the use of cardboard tubes, commonly called “cores” on the surface of which a predetermined amount of glue is distributed to allow the gluing of the paper web on the cores gradually introduced into the machine that produces the logs, commonly known as “rewinder”. Upon reaching the predetermined number of sheets wound on the core, the last sheet of the log being completed is separated from the first sheet of the subsequent log, for example by means of a jet of compressed air directed towards a corresponding pre-incision line. At this point, the log is unloaded from the rewinder. Patent EP1700805 describes a rewinding machine which works according to the above indicated operating scheme. The logs thus produced are then conveyed to a buffer which supplies one or more cutting-off machines by means of which the logs are transversely cut to obtain the rolls in the desired length.

The tubular cores are produced by means of machines commonly known as “tube-forming” machines configured to wind one or more cardboard webs around a mandrel creating a helical winding. Examples of tube-forming machines configured in this way are provided in EP3099481 and EP3212391B.

The reels, from which the cardboard webs are unwound, are loaded, with the aid of lifting devices controlled by an operator, onto special unwinding units that support the reels themselves during the production of the tubes. For this purpose, these reels are arranged, stacked on a pallet, in a parking station from which they must be picked up one at a time to be conveyed to the tube unwinding units. A frequently occurring drawback resides in the fact that the stacked reels tend to adhere to each other at the interface of the respective bases, this in relation to the fact that, in the production phase, the individual reels may be not perfectly detached from each other. Therefore, frequently, the operator assigned to picking up the reels is forced to exert a mechanical action on the reels to facilitate their detachment and therefore the picking up. This involves wasting time and risks for the safety of the operators.

The main object of the present invention is to obviate the aforementioned drawbacks. This result has been achieved, in accordance with the present invention, by adopting the idea of making a device and a method having the characteristics indicated in the independent claims. Other characteristics of the present invention are the subject of the dependent claims.

Thanks to the present invention, it is always possible to ensure the most correct detachment of each reel from the underlying reel of the stack arranged in the reel parking station enslaved to one or more tube forming machines using the same reels. Furthermore, a device in accordance with the present invention is relatively simple, both from a structural and a functional point of view, and helps to increase the efficiency of the cardboard tubes manufacturing process. In addition to this, the physical activity of the assigned operators is greatly reduced, which facilitates the activity of the operators themselves and increases the safety of the process.

These and further advantages and characteristics of the present invention will be better understood by every person skilled in the art thanks to the following description and the attached drawings, provided by way of example but not to be considered in a limiting sense, in which:

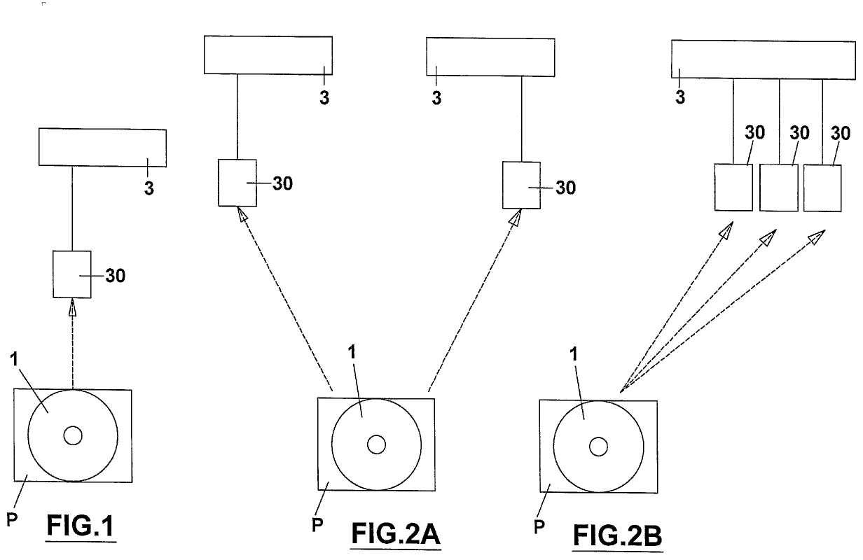

FIGS. 1-2B are simplified diagrams relating to possible positioning of tube molds and relative unwinders in a station for the production of cardboard tubes;

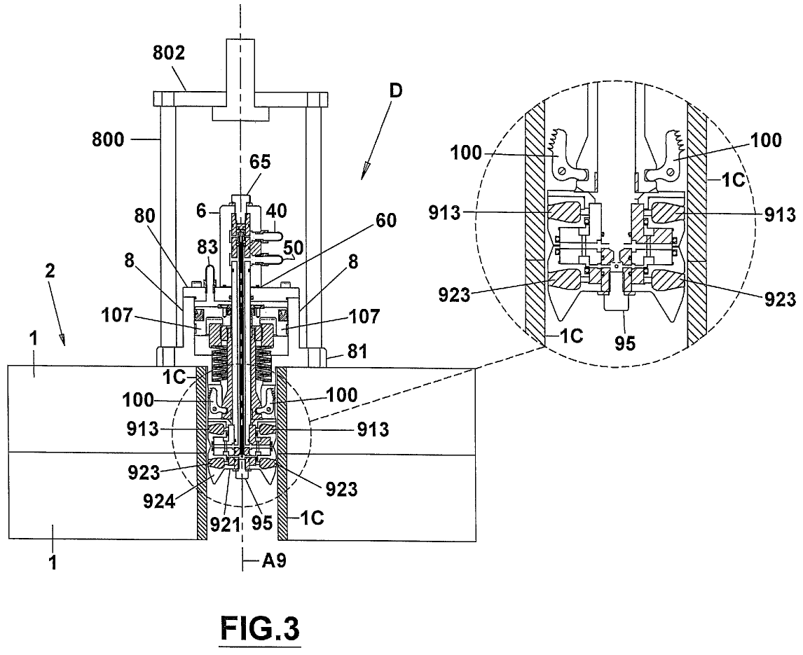

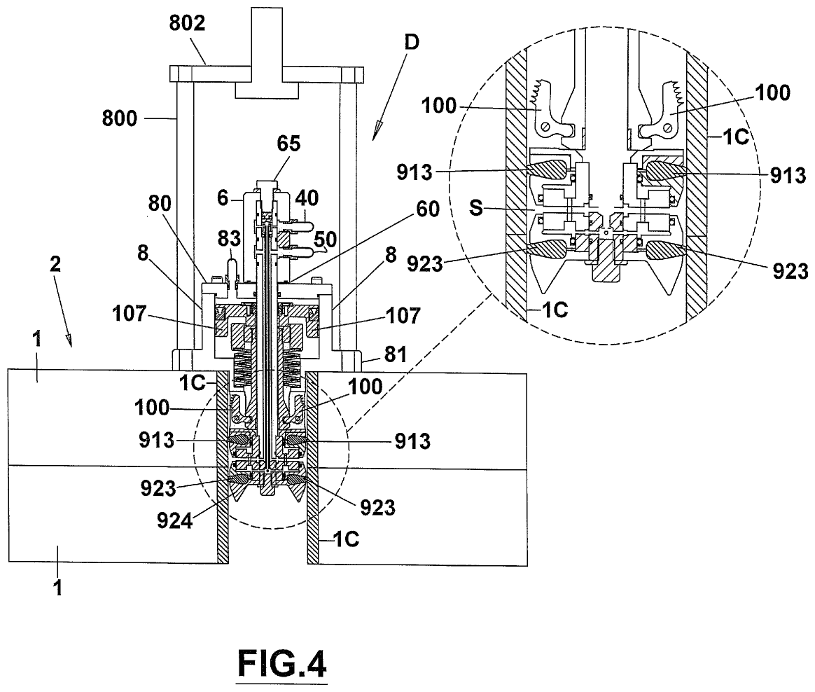

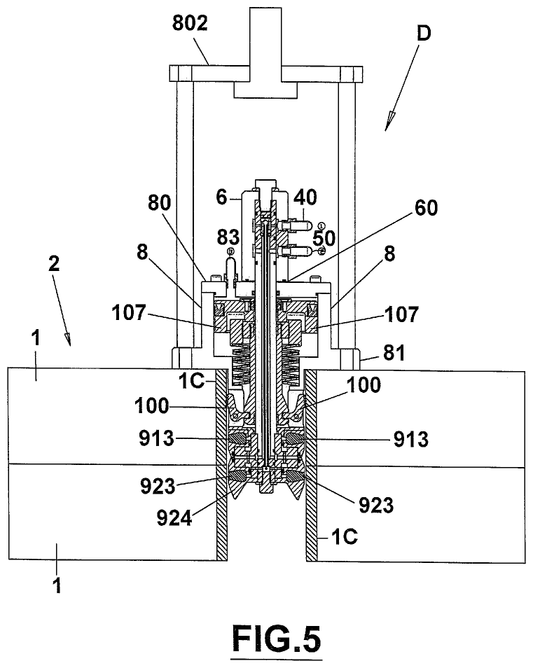

FIGS. 3-5 illustrate different operative configurations of a device for handling cardboard reels according to a possible embodiment;

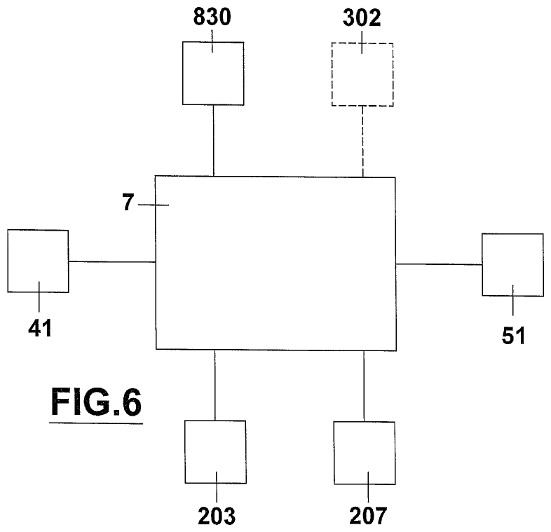

FIG. 6 is a simplified block diagram relating to a possible configuration of a system for controlling the moving parts of a device in accordance with the present invention;

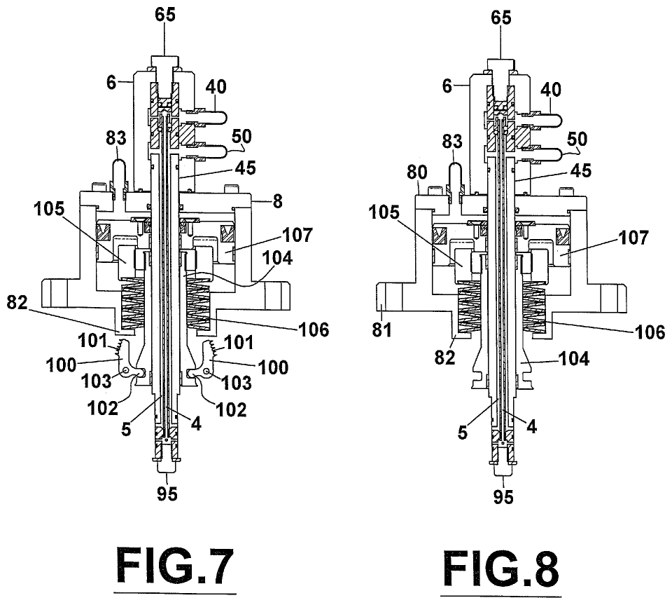

FIG. 7 represents a detail of FIG. 3;

FIG. 8 also represents a detail of FIG. 3;

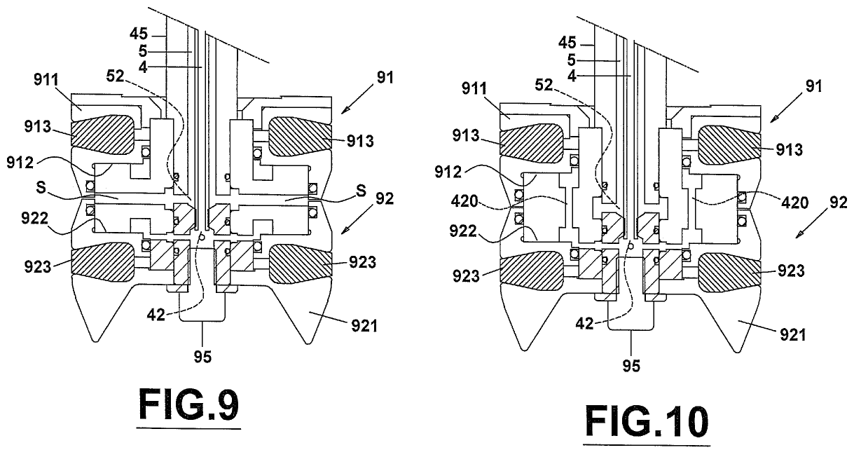

FIG. 9 is an enlarged detail of FIG. 3 showing the structure of the plates (91, 92) and the pressurizable space (S);

FIG. 10 illustrates the same elements shown in FIG. 9 according to a different section plane to better highlight the ducts (420);

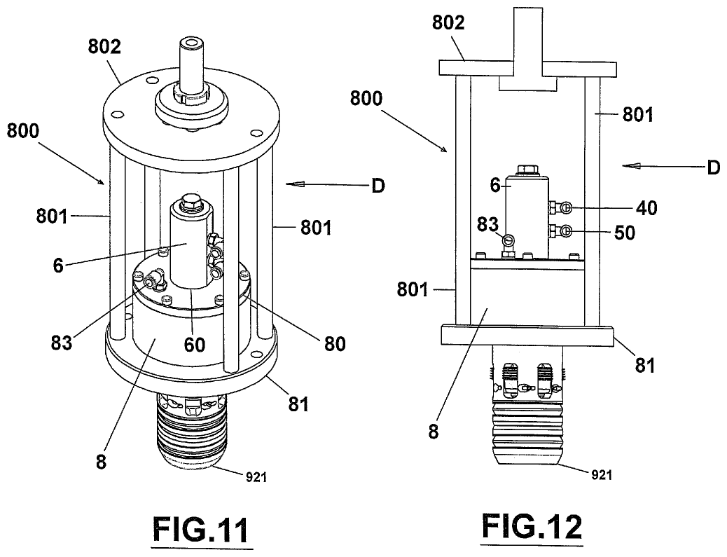

FIGS. 11 and 12 are two other views of a device according to the present invention;

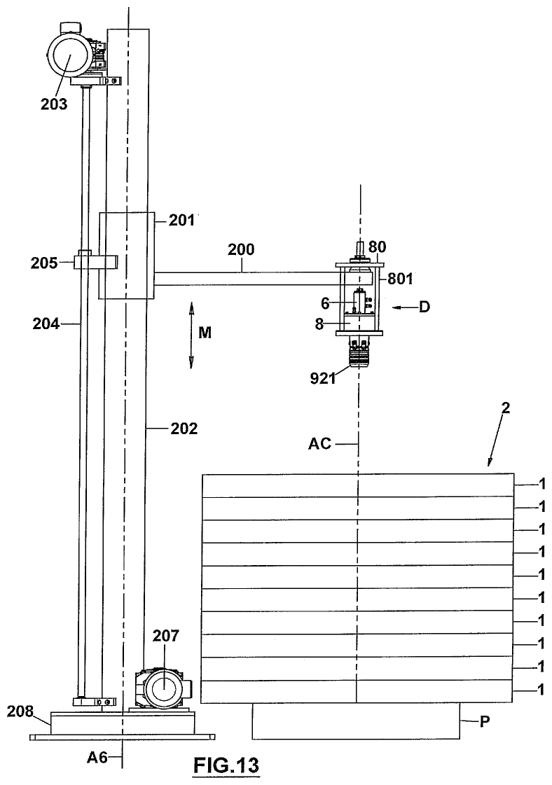

FIG. 13 is a schematic representation of a device in accordance with the invention mounted on a handling arm (200);

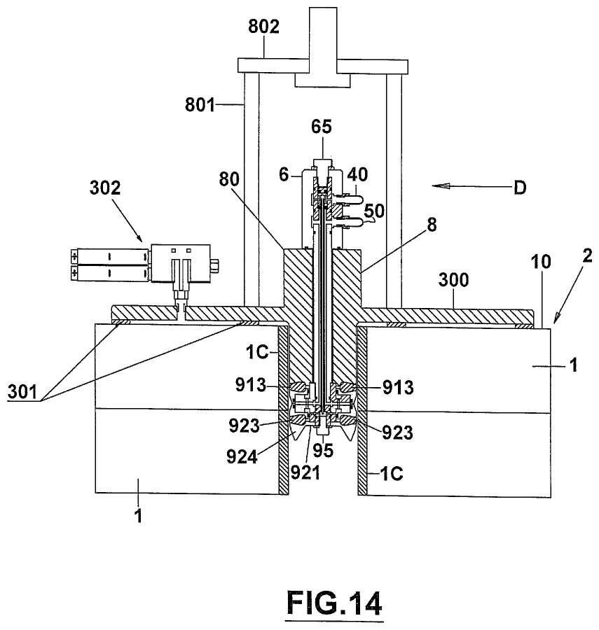

FIG. 14 schematically represents a further embodiment of the present invention.

Reduced to its essential structure and with reference to the figures of the attached drawings, a device (D) according to the present invention is configured to operate on the individual reels (1) from a stack (2) of reels arranged in a parking station (P) enslaved to one or more tube forming machines (3) which use reels (1) to produce cardboard tubes. The reels (1) are formed by a predetermined amount of cardboard web wrapped around a central tubular core (1C). The stack (2) is formed by a predetermined number of overlapping reels (1). The tube forming machines (3) are machines known per se, for example of the type described in the documents cited above.

In the block diagram of FIG. 1 there is only one tube forming machine (3), so that all the reels (1) taken from the stack (2) are destined to feed the same tube forming machine. In the block diagram of FIG. 2A there are two distinct tube forming machines (3), so that the reels (1) taken from the stack (2) are destined to feed two tube forming machines. In the block diagram of FIG. 2B there is only one tube forming machine (3) fed by three unwinders (30) to produce so-called multi-strip cardboard tubes, i.e. formed by overlapping the cardboard strips fed by the unwinders (30). In practice, in the diagrams of FIGS. 1-2B the reels (1) are transported from the parking station (P) to one or more unwinders (30) each of which feeds a tube forming machine (3).

A device according to the present invention is configured and structured to facilitate the detachment of each reel (1) of the stack (2) from the underlying reel.

With reference to the example shown in FIGS. 3-5 of the attached drawings, a device according to the present invention comprises two coaxial ducts (4, 5) with an upper side and a lower side, connected to respective inlets (40, 50) for the introduction of compressed air which are arranged on a distributor (6) positioned on the upper side of the same ducts (40, 50). Each of said inlets (40, 50) is controlled by a respective solenoid valve (41, 51) which, in turn, is operated by means of a programmable control unit (7) as further described below.

In the exemplary drawings of FIGS. 3-5, the duct (4) is inside the duct (5). The distributor (6) is mounted on the upper side of the external duct (5) by means of a bolt (65) screwed into the upper side of this duct. The inlets (40, 50) are radially oriented in the distributor (6) with respect to the coaxial ducts (4, 5) and are spaced apart by a predetermined value (h) thus forming an upper inlet (40) and a lower inlet (50) for the compressed air. The upper inlet (40) is in communication with the internal duct (4), while the lower inlet (50) is in communication with the external duct (5).

The lower base (60) of the distributor (6) is integral with the upper base (80) of a box-shaped body (8) which is crossed by the tubular ducts (4, 5) and has a lower base shaped as a flange (81). The box-like body (8) is integral with a maneuvering portion (800) which can be moved to and from the stack (2) by means of a movement arm (200) as further described below. In the example shown in FIGS. 3-5, said operating portion (800) is formed by a plurality of vertical rods (801) which connect an upper flange (802) to the lower flanged base (81) of said body (8), so as to contain the latter and the distributor (6) inside it.

On the lower side of the rod (45) formed by the coaxial ducts (4, 5) two plates (91, 92) are mounted, placed at a predetermined distance from each other, forming an upper plate (91) and a lower plate (92). The upper plate (91) includes a fixed upper flange (911) keyed on the rod (45), a movable lower flange (912) adapted to slide on the rod itself (45), and an elastic gasket (913) positioned between the flange fixed upper flange (911) and the lower movable flange (912) coaxially with the rod (45). Similarly, the lower plate (92) comprises a fixed lower flange (921) integral with the lower end of the rod (45), a movable upper flange (922) adapted to slide on the rod (45), and an elastic gasket (923) positioned between the fixed lower flange (921) and the movable upper flange (922) coaxially to the rod (45). For example, the fixed lower flange (921) is locked on the lower end of the rod (45) by means of a bolt (95). The outlet (42) of the internal duct (4) is between the movable flanges (912, 922) of the plates (91, 92). The drawings also show two ducts (420) that pneumatically connect the movable flanges (912, 922) with the outlet (42) of the duct (4). In practice, by introducing compressed air through the inlet (40), the movable flanges (912, 922) move in the direction of the respective fixed flanges (911, 921), each compressing the corresponding elastic gasket (913, 923) which, consequently, is forced to expand radially outwards.

The device by way of example represented in FIGS. 3-5 also comprises a mechanism apt to engage the internal surface of the cores (1C) of the reels (1). For example, this mechanism comprises a plurality of jaws (100) consisting of levers in the shape of an inverted “L” with a toothed front side (101), a rear side (102) constrained to a bushing (104) apt to slide on the surface of the external duct (5), and an intermediate part pivoted on a pin (103) oriented perpendicular to the surface of a casing (880) developed under the flanged part (81). Said casing has suitable openings (881) to allow the jaws (100) to come out. Therefore, by making the bushing (104) slide along the duct (5) the rotation of the levers (100) on the pins (103) is determined; this rotation causes the said toothed sides (101) to move away from the bushing (104) when the latter is pushed upwards and, vice versa, determines the approach of the toothed sides (101) to the bushing (104) when the latter is pushed down. In other words, said rotation determines the radial movement of the jaws (100) from and towards the longitudinal axis (A9) of the device. The upper part of the bushing (104) has a flange (105) which, in cooperation with a lower cup-like appendage (82) of the lower base (81) of the box-shaped body (8), defines a housing for an elastic element (106) coaxially fitted on the bushing (104). The flange (105) arranged on the upper part of the bushing (104) is integral with a piston (107) arranged between the same flange (105) and the upper base (80) of the box-shaped body (8). In addition, the upper base (80) of the box-like body (8) has an inlet (83) for the introduction of compressed air into it. Therefore, by introducing compressed air into the box-shaped body (8) through the inlet (83), the piston (107) is lowered, overcoming the resistance of the elastic element (106) and causing the lowering of the bushing (104), i.e. the approach of the toothed sides of the levers (100) to the bushing (104). On the other hand, when the introduction of compressed air through the inlet (83) of the box-like body (8) is interrupted, the bushing (104) is pushed upwards by the elastic element (106), which determines the removal of the toothed sides of the levers (100) from the bushing (104). The inlet (83) is also controlled by a solenoid valve (830) operated by the control unit (7). The drawings also show two ducts (420) that pneumatically connect the movable flanges (912, 922) with the outlet (42) of the duct (4).

In FIG. 13 the device described above is mounted on a handling arm (200) which allows it to be moved to and from the stack (2) set up in the reel parking station (P) (1) as indicated by the double arrow “M”. The reference “AC” in FIG. 13 indicates the axis of the reels (1). The arm (200) is provided with a carriage (201) sliding on a column (202). The carriage (201) is connected to an electric motor (203), arranged on the column (202), by means of a screw-nut screw connection (204, 205). The electric motor (203) controls the movement of the arm (200) to and from the stack (2) as indicated by the double arrow “M”. The length of the arm (200) is selected in such a way that the device (D) is moved to and from the stack (2) along the aforementioned axis (AC). The column (202) is mounted on a rotating base (206) whose rotation is controlled by a corresponding electric motor (207). The rotation axis of the rotating base (206) is indicated by the reference “A6”. Therefore, the arm (200) can be moved along the direction indicated by the double arrow “F”, i.e. parallel to the column (202), and can be rotated around the axis (A6) of the rotating base (206). By coordinating these movements, the arm (200) can therefore travel along a predetermined trajectory, in particular a transport trajectory of the reels from the parking point (P) to an unwinder (30).

The core surface engagement mechanism (1C) can be omitted.

FIG. 14 shows a further embodiment of the invention, in which the device (D) is equipped with a suction cup (300) for engaging the upper face (10) of the upper reel of the stack (2) instead of engaging its core (1C) as in the example previously described. The suction cup (300) is formed by a discoidal extension of the body (8) equipped with sealing gaskets (301) formed on the lower side of the same extension. An aspirator (302) is mounted on the upper side of the suction cup (300) to produce a vacuum in the space that forms between the reel (1) and the suction cup (300).

The device described above, if it also includes the core engagement mechanism (1C), can be used as follows.

By means of the arm (200) the box-like body (8) with its lower base (81) is placed in contact with the upper base of the reel (1) higher than the stack (2). The contact is detected by means of a mechanical probe (not visible in the drawings). In this condition, the upper plate (91) is inside the core (1C) of the reel (1) with which said base (81) is in contact, while the plate (92) is inside the core (1C) of the underlying reel. In fact, the distance (k) between the plates (91, 92) is such that, once the base (81) is placed against the upper face of the reel (1) higher than the stack (2), the plates (91, 92) are one inside this reel and the other inside the underlying reel. In this phase, compressed air is introduced through the inlet (83), so the levers (100) are set back, that is, close to the bushing (104). At this point, compressed air is blown through the internal duct (4). This determines the movement of the movable lower flange (912) of the plate (91) towards the respective fixed flange (911) and, at the same time, the movement of the upper movable flange (922) of the plate (92) towards the respective fixed flange (921). Consequently, the gaskets (913, 923) are compressed and expand by adhering to the internal surface of the cores (1C) of the highest reel of the stack (2) and of the reel below it. In this way, a space (S) substantially impermeable to air is formed between the plates (91, 92). Then, compressed air is introduced through the external duct (5) which flows into the aforementioned space (S) and is released at the interface between the lower base of the reel in which the plate (91) is inserted and the upper base of the reel in which the plate (92) is inserted. Therefore, a pressure is produced in the space (S) between the plates (91) and (92) which determines the detachment of the upper reel from the lower reel.

Subsequently, the injection of compressed air into the internal duct (4), into the external duct (5) and through the inlet (83) is interrupted. With the interruption of the compressed air in the duct (4) the movable flanges of the plates (91, 92) return to their initial positions and the gaskets (913, 923) also return to their initial condition of non-contact with the cores (1C). In this phase, the supply of compressed air to the duct (5) is no longer necessary because the reels have already been detached due to the pressurization of the space (S) previously operated. The interruption of the compressed air supply through the inlet (83) arranged on the box-like body (8) causes the bushing (104) to lift, pushed upwards by the elastic member (106), and therefore the rotation of the levers (100) on the pins (103), whereby the toothed sectors (101) of the same levers (100) move away from the bushing (104) and engage the inner surface of the core (1C) of the upper reel of the stack (2). In this condition, the upper reel (1) of the stack, (2) is engaged by the arm (800) through the engagement mechanism which, in the example described above, is the mechanism comprising the levers (100). The arm (200) can then be led to an unwinder (30) with the reel (1) hooked to it. The release of the reel will be determined by a new introduction of compressed air through the inlet (83) which will cause the levers (100) to approach the bushing (104) and therefore the disengagement of the toothed sector of the same levers from the internal surface of the respective core (1C).

With reference to the embodiment example shown in FIG. 14, in which the mechanism for engaging the cores (1C) is not provided, but the suction cup (300) is provided, the pressurization phase of the aforementioned space (S) and detachment of the upper reel of the stack from the underlying reel occurs as described previously. In this case, the engagement of the upper reel, so its removal from the stack (2), takes place due to the effect of the suction cup (300) which binds the reel itself to the device (D), and therefore to the arm (BM), acting on the upper side of the reel instead of acting on the respective core (1C) as in the previous example.

As previously stated, a device according to the present invention may not be provided with the core engagement mechanism (1C). In this case, the steps previously described in relation to the engagement of the cores (1C) do not take place and the device is used only to cause the detachment of the reels from the underlying reels of the stack by pressurizing the space (S) between the plates (91, 92). The transport of the reel thus detached, from the parking point (P) where the stack (2) is located to the unwinder (30) to which the reel is destined, can be carried out with already known methods, for example making use of the so-called “weightless” manipulators.

More generally, a device (D) for handling cardboard reels in accordance with the present invention is a device configured to engage stacked cardboard reels (1) and comprises a rod (45) on which are arranged:
a unit with two axially opposed plates (91, 92), provided with respective radially expandable parts (913, 923), and spaced apart by a predetermined value (k) along an axial direction (A9) of said rod so as to form a pressurizable space (S) between said plates, said space (S) being delimited above and below by opposite surfaces (912, 922) of said plates (91, 92);
means for controlling the radial expansion of said parts (913, 923);
pressurization means for pressurizing said space (S).

In accordance with the present invention, the device (D) can also comprise a mechanism for engaging the reels with:
a second unit, positioned above the first unit on said rod (45), comprising a predetermined number of radially extractable and respectively retractable jaws (100);
means for radially moving said jaws (100).

In accordance with a further embodiment of the invention, the device (D) may also comprise a mechanism for engaging the reels with:
a second unit, positioned above the first unit on said rod (45), comprising a suction cup (300) subservient to an aspirator (302) mounted on the same suction cup (300). In accordance with the present invention, the said units can be integrated in a single device even though they are intended to perform different functions: the first unit controls the detachment of the upper reel of the stack from the underlying reel, while the second unit controls the withdrawal of the upper reel from part of the device itself which, therefore, can be configured to be suitable for facilitating the detachment of the reels and also suitable for gripping the reels detached from the stack. Depending on the operating phase of use of the manipulation device, said units can all be active simultaneously or they can be active not simultaneously as previously described. In particular, said units can be activated according to a sequence which involves, in order, the radial expansion of the radially expandable parts of the plates (91, 92), the pressurization of the space (S), and subsequently the actuation, that is the extraction, of the jaws (100). In a subsequent phase, said units can be activated according to a sequence which involves the retraction of the radially expandable parts of the plates (91, 92) and, subsequently, the retraction of the jaws (100) to determine the release of the reel (1) previously engaged from the same jaws (100). Or, said units can be activated according to a sequence which involves, in order, the radial expansion of the radially expandable parts of the plates (91, 92), the pressurization of the space (S), and subsequently the activation of the aspirator (302) and, in a subsequent phase, the deactivation of the aspirator (302) to determine the release of the reel (1) previously engaged by the suction cup (300).

The activation of said first and second units is controlled by the control unit (7) by activating the solenoid valves (41, 51, 830) in the desired sequence. In the diagram of FIG. 6 the programmable control unit (7) is also connected with the aspirator (302) and the motors (203, 207).

Preferably, said plates (91, 92) are enslaved to a first duct (4) which supplies compressed air through which the respective gaskets (913, 923) expand. Furthermore, preferably, the pressurization of the space (S) between the plates (91, 92) is achieved by means of a second conduit (5) coaxial and external to the first (4).

Preferably, in accordance with the present invention, the aforementioned rod (45) is constituted by the coaxial ducts (4) and (5).

Preferably, in accordance with the present invention, the actuation of the jaws (100) involves the use of an elastic member (106) cooperating with a pneumatic piston (107) by means of a guide (which in the previous example is made by the bushing 104) on which both the elastic body (106) and the pneumatic piston (107) act.

In accordance with the example described above, the axial direction (A9) coincides with the common axis of the ducts (4) and (5), while the opposite surfaces of the plates that delimit the pressurizable space (S) below and above are defined by movable flanges (912, 922).

Furthermore, in the example described with reference to the embodiment shown in FIGS. 3-5, the means for controlling the radial expansion of said gaskets (913, 923) are constituted by the groups formed by the respective pairs of fixed and movable flanges (911, 912; 921, 922) and by the control system for introducing compressed air through the duct (4).

A possible way of pressurizing the space (S) between the plates (91, 92) consists in providing the duct (5) whose outlet is precisely in correspondence with the space (S). In the example described with reference to the embodiment shown in FIGS. 3-5, the jaws (100) consist of the levers pivoted on the pins (103) and constrained at the rear of the bushing (104). These levers, in the example described with reference to the embodiment shown in FIGS. 3-5, are moved by means of the elastic element (106) and the piston (107).

A device according to the present invention can be used to implement an operating method comprising the following operating steps:
arrangement of a stack (2) of cardboard reels (1) in a parking point (P) of a site for the production of cardboard tubes comprising at least one tube (3) and a corresponding unwinder (30) by means of which the tube maker (3) receives a cardboard strip unwound from a reel (1) positioned on the unwinder (30), each reel (1) having a central tubular core (1C);
insert, in the central tubular core (1C) of the top reel of the stack (2), two plates (91, 92) spaced apart by a predetermined value along a predetermined axial direction (A9) and provided with respective parts (913, 923) radially expandable, forming a pressurizable space (S) at the interface between said reel and the underlying reel of the stack (2), said pressurizable space (S) being formed by opposite surfaces (912, 922) of said plates;
pressurizing said space (S) so as to determine the detachment of said reel from the underlying reel.

The aforementioned operating method may also include the following further operating phases;
engage said central tubular core (1C) from the inside;
bringing the pressure in said space (S) back to a value corresponding to the atmospheric pressure;
moving said reel along a predefined path while the respective central tubular core (1C) is engaged from the inside.

Alternatively, the highest reel of the stack can be engaged on an external surface thereof, for example its upper face as previously described.

Preferably, in accordance with the above operating method, the radially expandable parts (913, 923) of the plates (91, 92) are elastic gaskets which expand radially when they are compressed and return to an initial unexpanded configuration when they are not compressed.

Furthermore, preferably, the compression of the said elastic gaskets is due to a crushing of the gaskets themselves between two opposite surfaces (911, 912; 921, 922) of the plates (91, 92), the said opposite surfaces being a fixed surface (911; 921) and a movable surface (912; 922) of each plate (91, 92) between which the gaskets (913, 923) are positioned. Preferably, said crushing is determined by the movement of said movable surfaces by means of compressed air which pushes each movable surface towards the respective fixed surface.

Preferably, in accordance with this operating method, the pressurization of said space (S) is performed by means of a duct (5) fed with compressed air and having an outlet in correspondence with the same space (S).

Furthermore, preferably, in accordance with the present operating method, the central tubular core (1C) is engaged from the inside by means of jaws (100) inserted in the same tubular core (1C) and adapted to exert a radial pressure on the internal surface of this last.

It is also advantageously provided that the highest reel of the stack is engaged on its upper face by means of a suction cup (300).

In practice, the details of execution can in any case vary in an equivalent manner as regards the individual elements described and illustrated, without thereby departing from the idea of the solution adopted and therefore remaining within the limits of the protection granted by this patent in accordance with the following claims.

1. Device for handling cardboard reels, characterized in that it includes a main body (8) with a rod (45) on which are arranged:
a first unit with two axially opposed plates (91, 92), provided with respective radially expandable parts (913, 923), and spaced apart by a predetermined value along an axial direction (A9) of said rod (45) so to form a pressurizable space (S) between said plates, said space (S) being delimited above and below by opposite surfaces (912, 922) of the same plates (91, 92);
means for controlling the radial expansion of said parts (913, 923);
pressurization means for pressurizing said space (S).

2. Device according to claim 1 characterized in that it comprises:
a second unit, positioned above the first unit, comprising a predetermined number of radially extractable and respectively retractable jaws (100);
means for radially moving the jaws (100).

3. Device according to claim 1, characterized in that it comprises a suction cup (300) connected to a corresponding pneumatic aspirator (300).

4. Device according to claim 1 characterized in that each of said plates (91, 92) is constituted by a fixed flange (911, 921) and a mobile flange (912, 922) positioned on said rod (45) such that the movable flanges (912, 922) are respectively opposed, forming the aforementioned pressurizable space (S), in that between the fixed flange and the movable flange of each plate there is an elastic gasket which extends radially when it is subjected to compression, and in that the movable flange of each plate is positioned on said rod (45) to be moved pneumatically towards the respective fixed flange and thus cause the respective elastic gasket to be compressed.

5. Device according to claim 1, characterized in that each of said plates (91, 92) is constituted by a fixed flange (911, 921) and a mobile flange (912, 922) positioned on said rod (45) such that the movable flanges (912, 922) are respectively opposed, forming the aforementioned pressurizable space (S), in that between the fixed flange and the movable flange of each plate there is an elastic gasket which extends radially when it is subjected to compression, and in that the movable flange of each plate is positioned on said rod (45) to be moved pneumatically towards the respective fixed flange and thus cause the respective elastic gasket to be compressed and in that the pneumatic movement of said movable flanges (912, 922) is controlled by introducing compressed air into a first duct (4) which has an outlet in correspondence with the same movable flanges.

6. Device according to claim 1 characterized in the pressurization of the space (S) between the plates (91, 92) is achieved by means of a second duct (5).

7. Device according to claim 1, wherein in that each of said plates (91, 92) is constituted by a fixed flange (911, 921) and a mobile flange (912, 922) positioned on said rod (45) such that the movable flanges (912, 922) are respectively opposed, forming the aforementioned pressurizable space (S), in that between the fixed flange and the movable flange of each plate there is an elastic gasket which extends radially when it is subjected to compression, and in that the movable flange of each plate is positioned on said rod (45) to be moved pneumatically towards the respective fixed flange and thus cause the respective elastic gasket to be compressed;
wherein the pneumatic movement of said movable flanges (912, 922) is controlled by introducing compressed air into a first duct (4) which has an outlet in correspondence with the same movable flanges and the pressurization of the space (S) between the plates (91, 92) is achieved by means of a second duct (5),
device characterized in that said first and second ducts (4, 5) are coaxial with each other, with the second duct (5) external to the first duct (4), and form said rod (45).

8. Device according to claim 1 wherein the device comprises:
a second unit, positioned above the first unit, comprising a predetermined number of radially extractable and respectively retractable jaws (100);
means for radially moving the jaws (100);
device characterized in that said jaws (100) are constituted by levers controlled by an elastic element (106) and a pneumatic piston (107).

9. Method for handling cardboard reels, comprising a step of preparing a stack (2) of cardboard reels (1) in a parking point (P) of a site for the production of cardboard tubes comprising at least one tube-forming machine (3) and a corresponding unwinder (30) by means of which the tube-forming machine (3) receives a cardboard strip unwound from a reel (1) positioned on the unwinder (30), each reel (1) having a central tubular core (1C), characterized in that it includes the following further operational phases:
inserting, in the central tubular core (1C) of the top reel of the stack (2), two plates (91, 92) spaced apart by a predetermined value (k) along a predetermined axial direction (A9) and provided with respective radially expandable parts (913, 923), forming a pressurizable space (S) at the interface between said reel and the underlying reel of the stack (2), said pressurizable space (S) being formed by opposing surfaces (912, 922) of said plates;
pressurizing said space (S) so as to determine the detachment of said reel from the underlying reel.

10. Method according to claim 9 characterized in that it involves a further step of engagement of the reel (1) detached from the underlying reel following the pressurization of said space (S).

11. Method according to claim 9, wherein it involves a further step of engagement of the reel (1) detached from the underlying reel following the pressurization of said space (S), method characterized in that the reel (1) detached from the underlying reel is engaged at the respective central tubular core (1C).

12. Method according to claim 9, wherein it involves a further step of engagement of the reel (1) detached from the underlying reel following the pressurization of said space (S), method characterized in that the reel (1) detached from the underlying reel is engaged in correspondence with an upper face (10) thereof.
